(19) United States
(12) Patent Application Publication
(10) Pub. No.: US 2013/0187495 A1
(43) Pub. Date: Jul. 25, 2013

(54) CONTACT PIECE CONTAINING PRECIOUS METAL ON A SPRING SUPPORT HAVING A ROTATIONALLY SYMMETRICAL BENDING MOMENT

(71) Applicants: Bernd Gehlert, Bruchkobel (DE); Rolf Paulsen, Hanau (DE); Ingo Prunzel, Bruchkoebel (DE); Reinhold Weiland, Hanau (DE); Patrick Baake, Hanau (DE)

(72) Inventors: Bernd Gehlert, Bruchkobel (DE); Rolf Paulsen, Hanau (DE); Ingo Prunzel, Bruchkoebel (DE); Reinhold Weiland, Hanau (DE); Patrick Baake, Hanau (DE)

(73) Assignee: HERAEUS MATERIALS TECHNOLOGY GMBH & CO. KG, Hanau (DE)

(21) Appl. No.: 13/824,770

(22) PCT Filed: Oct. 10, 2011
(86) PCT No.: PCT/EP2011/005049

§ 371 Date: Mar. 18, 2013

(30) Foreign Application Priority Data
Oct. 13, 2010 (DE) 10 2010 048 189.0

(51) Int. Cl. H02K 11/00

(52) U.S. Cl. CPC H02K 11/0094
USPC 310/71; 174/126.1

(57) ABSTRACT

A spring contact for a sliding contact is provided having a terminal region and at least one contact region including an elongated spring element and a precious metal. The spring contact includes a conductive spring support and at least one contact piece. The spring support has essentially symmetrical rigidity in some regions in a plane perpendicular to the elongated extension of the spring support, and is made of a conductive material essentially free of precious metal. The contact piece(s) is/are conductively connected to the spring support, and has at least one surface to form the sliding contact. A surface of the contact piece(s) is made of a precious metal or a precious metal alloy. A slip ring transmitter for a motor or dynamo is also provided having a spring contact of this type, wherein the surface of the contact piece(s) touch(es) against the slip ring(s) in a conductive manner.

### CROSS-REFERENCE TO RELATED APPLICATIONS

This application is a Section 371 of International Application No. PCT/EP2011/005049, filed Oct. 10, 2011, which was published in the German language on Apr. 19, 2012, under International Publication No. WO 2012/048839 A1 and the disclosure of which is incorporated herein by reference.

### BACKGROUND OF THE INVENTION

The invention relates to a spring contact for a sliding contact having a terminal region and at least one contact region comprising an elongated spring element and a precious metal.

The invention also relates to a slip ring transmitter comprising a spring contact of this type as well as a motor and a dynamo having a slip ring transmitter of this type.

Spring contacts for sliding contacts are well-known from the prior art. The purpose of sliding contacts is to transmit current from a resting part of an apparatus to a moving second part of the apparatus. Sliding contacts or gliding contacts are used mainly in motors and dynamos, in which current is transmitted to rotating parts. This produces so-called slip ring transmitters, in which the spring contact slides on a slip ring and thus establishes a conductive connection between spring contact and slip ring.

The contact region is an electrical supply lead or discharge lead to or from the actual sliding contact or gliding contact by which a motor is operated or by which a current generated by a generator is discharged. In this context, the contact region can serve both for fastening the spring contact and for establishing the conductive connection to the electrical connection. Fastening of this type can be attained, for example, by riveting, spot welding and/or soldering.

Spring contacts are most often designed such that a leaf spring presses against a slip ring or another counter-contact and thus establishes electrical contact. In this context, the spring force of the leaf spring is utilized to generate permanent pressure of the electrical contact on the counter-contact, which ensures a permanently conductive connection even if the counter-contact moves with respect to the leaf spring of the spring contact. These generic spring contacts are known, for example, from U.S. patent application Publication 2010/0096 168 A1.

The spring contacts are often made from a precious metal or a precious metal alloy, in order to prevent passivation of the surface of the spring contact, in particular of the electrical contact, and thus ensure a permanently conductive connection. For this purpose, it is sufficient if the spring contact has a jacket made of a precious metal or a precious metal alloy. Usable precious metals and precious metal alloys are limited in that they need to possess suitable mechanical properties in order not to worsen, or at least maintain, the spring force of the spring contact. The modulus of elasticity and elastic deformation range of the material must be matched to the mechanical requirements of the spring contact. Therefore, only certain precious metals and precious metal alloys come into consideration.

Moreover, another disadvantage during the installation of the leaf spring is that the leaf spring needs to be inserted exactly in a certain position, in order to ensure that the contact is sufficiently strong. The tolerances applying to the installation of a leaf spring of this type are therefore narrow. Moreover, spring contacts containing precious metals are expensive, and some of them are elaborate in design.

### BRIEF SUMMARY OF THE INVENTION

It is therefore an object of the invention to provide a spring contact, a slip ring transmitter, a motor, and a dynamo that overcome the disadvantages of the prior art. A spring contact of this type should, first, be easy to install and/or the tolerances during installation should be as generous as possible, and, second, its design should be as inexpensive as possible.

The object of the invention is met in that the spring contact comprises a conductive spring support and at least one contact piece, wherein the spring support has essentially symmetrical rigidity in some regions in a plane perpendicular to the elongated extension of the spring support, and is made of a conductive material that is essentially free of precious metal, and wherein the at least one contact piece is conductively connected to the spring support, comprises at least one surface to form the sliding contact, and the material of the surface of the contact piece comprises a precious metal or a precious metal alloy.

In the scope of the present invention, a material that is essentially free of precious metal shall be understood to also include a material, in which small amounts or traces of precious metal are still present. In order to attain the goal of designing the spring contact as inexpensively as possible, it is perfectly adequate to use a non-precious spring wire. Any elaborate cleaning of the material in order to remove precious metals would be contrary to the purpose to be achieved. In the scope of the present invention, a precious metal shall be understood to mean, in particular, platinum, gold, silver, rhodium, palladium, and iridium.

In this context, the invention can provide that at least one contact piece is connected to the spring support by resistance welding, laser welding, spot welding, gluing, soldering, riveting and/or sintering.

Moreover, the invention can provide that at least one contact piece is cylindrical, spherical, U-shaped, profiled with welding nipples, or semi-spherical in shape.

Spring contacts according to the invention can also be characterized in that at least one contact piece consists of solid precious metal or a precious metal alloy or a jacketed wire or a jacketed sphere with a precious metal-containing jacket.

The invention can just as well provide that the spring support is flat, hollow-shaped or profiled at the connection to the contact piece, or the spring support is flat, hollow-shaped or profiled at at least one connection to the contact pieces.

A connection of this type can be embossed. In this context, the embossing can also serve to jam or clamp the contact piece or contact pieces. The opening formed by the embossing then serves not only for contacting, but also for bracketing the contact pieces.

In this context, the invention can provide the embossing to be situated opposite on both sides of a spring support with a circular cross-section, in particular the spring support comprises two parallel planar embossings, which preferably are arranged in the middle of the spring support.

Flat embossings serve, first, to ensure that the arms of the spring support holding the contact pieces are bent at a defined position and in a defined direction when the V-shaped spring support is being bent. What this can also achieve in a spring support having two contact pieces is that the two contact pieces of a kinked spring support are situated exactly in position opposite from each other. On the other hand, the flat embossings serve to ensure that the spring supports can be fastened to a planar component in a stable manner. A flat circuit board to which a spring support of this type is fastened can be connected to the flat embossings in a planar manner. Moreover, the spring support can then be twisted less easily. During installation or mounting of spring supports of this type, it is necessary to ensure correct positioning. Having the spring support resting in a planar manner on a substrate, a circuit board or another component, the invention also attains the result that the spring support arms having the contact pieces extend from the substrate, circuit board or another component at the correct angle.

Planar and non-planar embossings can be provided as pre-determined bending sites.

The invention can provide at least two contact pieces at two ends of a V-shaped spring support.

In this context, the invention can provide the connection region to be arranged in the middle of the spring support, wherein a flat embossing and/or at least one notch-shaped embossing for bending of the V-shape is provided in the region of a bevel or bevels of the V-shaped spring support, preferably in the middle with respect to two contact pieces.

This allows a clamping contact to be formed, in which a slip ring is arranged between the two spring support arms holding the contact pieces. This produces a more stable contact, i.e. the contacting itself is interrupted less frequently, since the contact pieces slide over the slip ring from both sides.

Particularly advantageous spring contacts are characterized in that the spring support is 60 mm to 250 mm, preferably 100 mm to 200 mm, particularly preferably 150 mm, in length.

Moreover, the invention can provide that the contact piece(s) is/are 2 mm to 15 mm, preferably 5 mm to 10 mm, particularly preferably 8 mm, in width and/or length.

If the contact piece(s) is/are spherical in shape, the invention can provide the diameter of the spherical contact piece(s) to be 0.3 mm to 2 mm, preferably 0.5 mm to 1.5 mm, particularly preferably 1 mm.

The invention can also provide the spring support to be a spring wire having a round cross-section with symmetrical rigidity, at least in regions thereof, in the cross-sectional plane.

However, it is also feasible to generate a preferred direction of the spring force of the spring support by providing on the spring support a suitable deformation, for example an embossing, that deviates from the otherwise symmetrical shape of the spring support.

An alternative embodiment of the invention provides the spring support to be a twisted leaf spring that has symmetrical rigidity with respect to at least one region of the twisted leaf spring in the plane perpendicular to the torsion axis.

The invention can provide the spring support to have symmetrical rigidity in regions thereof in a plane perpendicular to the elongated extension of the spring support.

The region of symmetrical rigidity can comprise the majority of the length of the spring support or even the entire spring support.

Moreover, the invention can provide the spring support and/or the contact piece(s) to be pieces of wire having a diameter of up to 2 mm, preferably having a diameter of 0.1 mm to 1 mm, particularly preferably 0.5 mm.

Spring contacts according to the invention can also be characterized in that the spring support comprises steel and/or copper and/or beryllium, in particular in that it consists of stainless steel or copper and beryllium, in particular in that it consists of CuBe2.

Accordingly, the material of which the spring support consists is a non-precious metal material with spring-like elasticity.

In this context, CuBe2 is to be understood to be a mixture, with spring-like elasticity, of copper and beryllium containing approximately 98% by weight copper and 2% by weight beryllium. The mixture is not a single-phase alloy. The mixture, or micro-structure of the various phases, causes the spring support to possess good elastic properties.

According to the invention, at least one contact piece can comprise a precious metal, in particular an intermetallic alloy comprising gold, silver, palladium and/or platinum.

The invention can also provide at least one contact piece to consist of an Au—Ag—Pd alloy or to be a jacket wire having a precious metal jacket comprising Au, Ag and/or Cu, in particular an Au—Ag—Cu alloy.

The invention also relates to a slip ring transmitter comprising a spring contact of this type, in which the contact piece(s) touch(es) via the surface against at least one slip ring in a conductive manner.

The invention also relates to an electrical motor having a slip ring transmitter of this type.

Finally, the invention also relates to a dynamo having a slip ring transmitter of this type.

The invention is based on the surprising finding that the spring support is achieved to have symmetrical rigidity by the use of a simple wire or a twisted spring, and thus a more generous tolerance is afforded during the installation of the spring contact, since the spring contact can be moved also in the directions perpendicular to the spring force pressing the contact onto the counter-contact.

Moreover, only the electrical contact of the contact piece needs to be manufactured from a precious metal or a precious metal alloy. This is advantageous in that the reduced use of precious metals saves on costs. Another advantage is that the precious metal or the precious metal alloy no longer has to possess special elastic properties, since the spring support, rather than the contact region, determines the elastic properties of the spring contact. Accordingly, it is also feasible to use precious metals or precious metal alloys that could not be used thus far owing to their unfavorable elastic properties. In particular, it is now feasible to use particularly wear-resistant precious metal alloys, such that the contact region remains conductive for a long period of time.

The contact piece therefore only serves to form the actual sliding contact or gliding contact. The elastic properties of the spring contact are determined completely or at least essentially by the spring support. The properties that are essential for the spring contact, namely the elastic and contact-establishing properties, are therefore determined separately from each other by the two components, namely the spring support and the contact piece, and can be adjusted separately from each other by the design according to the invention.

Embossings can be used to easily bend even a wire having a round cross-section into V-shape. Moreover, if planar embossings are provided, the installation and/or mounting of spring supports according to the invention at an exact position is made much simpler. Accordingly, the advantages provided by a leaf spring over a spring having a design including a round cross-section are compensated by the planar apposition on the planar embossing.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic perspective view showing a first embodiment of a spring contact according to the invention having a cylindrical spring support and contact piece;

FIG. 2 is a schematic perspective view showing a second embodiment of a spring contact according to the invention having a cylindrical spring support and spherical contact piece;

FIG. 3 is a schematic lateral view showing a third embodiment of a spring contact according to the invention having two contact pieces; and

FIG. 4 is a schematic lateral view showing a fourth embodiment of a spring contact according to the invention having two contact pieces.

### DETAILED DESCRIPTION OF THE INVENTION

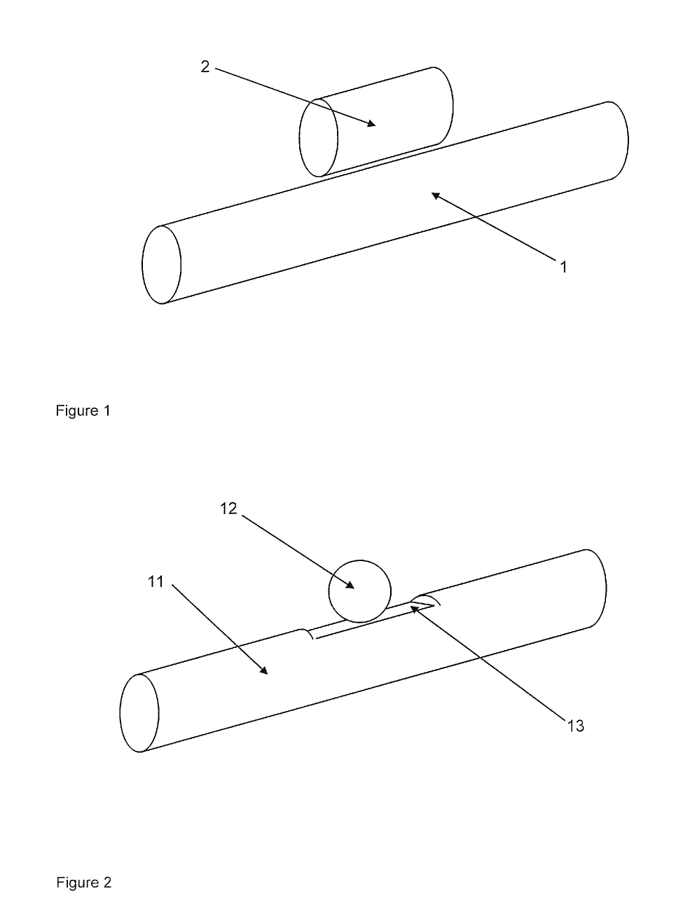

FIG. 1 shows a schematic view of a spring contact according to an embodiment of the invention having a cylindrical spring support 1, which is made, for example, from a wire having a circular cross-section. A cylindrical contact piece 2 is arranged on the spring support 1 and can also be a piece of wire. The spring support 1 consists of a conductive elastic material, for example of an alloy, such as CuBe2, or, as well, of stainless steel. The contact piece 2 is made of a solid metal wire comprising a precious metal alloy or a precious metal. A piece of jacketed wire can just as well be used as contact piece 2, wherein the jacket comprises a precious metal or a precious metal alloy. Gold alloys are particularly well-suited as precious metal alloys of the contact piece 2.

Both ends of the spring support 1 are well-suited as a contact region for the spring contact. The purpose of the contact region is to connect the spring contact to a conductor, whereby a voltage can be applied to the spring contact. Simultaneously, the spring contact can be fastened to and fixed in place on the contact region.

The contact piece 2 is connected to the spring support 1 by a solder (not shown) that is arranged between the contact piece 2 and the spring support 1 and connects both in a conductive manner.

FIG. 2 shows a schematic view of another embodiment of a spring contact having a cylindrical spring support 11 and a spherical contact piece 12. For the spherical contact piece 12 to be taken up better, the spring support is provided with a connecting surface 13 on which the contact piece 12 is connected to the spring support 11 by a conductive adhesive (not shown). The connecting surface 13 is generated by embossing the cylindrical spring support 11. In the course of embossing, the connecting surface 13 can also be provided with a profile. The provision with a profile can, for example, enlarge the surface area at the connecting surface 13, in order to generate a firmer connection with the adhesive. Moreover, the provision of a profile can ensure that a direct connection of the spring support 11 to the contact piece 12 is generated by tips or edges of the profile of connecting surface 13 being pressed into the contact piece 12. If a non-conductive adhesive is used, it is necessary to produce a conductive connection between the spring support 11 and the contact piece 12. This can be attained, for example, by a conductive coating or by direct connection of the connecting surface 13 to the contact piece 12.

Alternative profiling of the contact surface 13 is feasible as well. Accordingly, the shape of the contact surface 13 can be made to match the shape of the contact piece 12. This is of advantage, in particular, if the connection of the contact piece 12 to the spring support 11 is to be established by a welding procedure or if only a small amount of solder or adhesive is to be used.

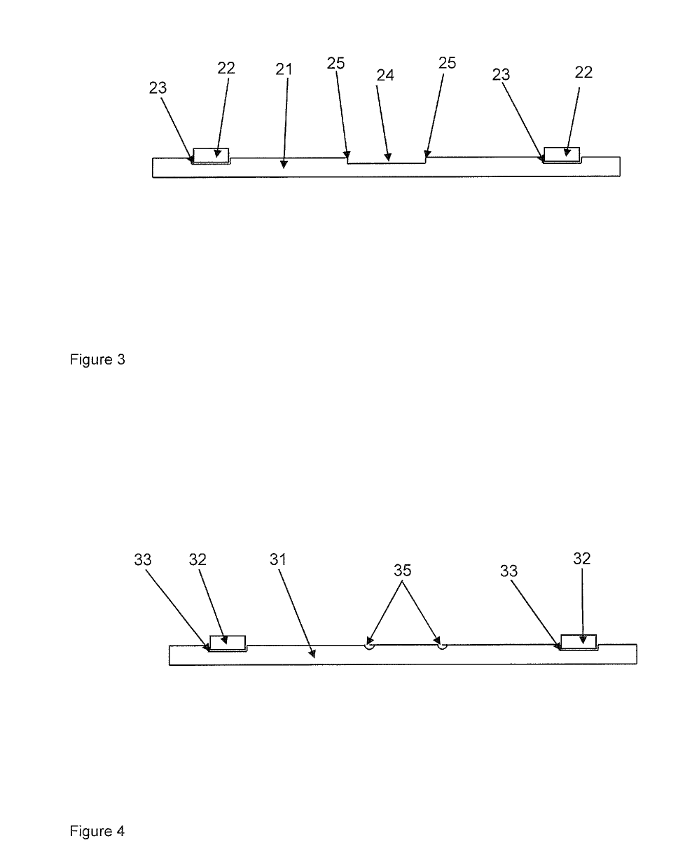

FIG. 3 shows a further embodiment of a spring contact having a spring support 21, at the two ends of which cylindrical contact pieces 22 are connected to the spring support 21. For better positioning of the contact pieces 22, two embossings having connecting surfaces 23 are provided in the spring support 21. The connecting surfaces 23 can be embossed just like the connecting surfaces 13 according to FIG. 2. Another embossing 24 is provided in the middle of the spring support 21 and can be used as a contact region and fastening region.

The spring contact can be beveled at the edges of the embossing 24 in order to generate a V-shaped spring contact. At both edges 25 of the embossing 24, the spring support 21 can be beveled by 45° with respect to the embossing 24, such that the two arms of the spring support 21 include an angle of approximately 90°. Obviously, other bevel angles can be produced as well in order to generate V-shaped spring contacts having different angles. A slip ring (not shown) connected to the two contact pieces 22 can be arranged between the arms of the angled spring support 21. For this purpose, the slip ring is clamped between the two contact pieces 22 such that the spring force of the two arms of the spring support 21 presses the contact pieces 22 onto the slip ring and thus a conductive connection extending from the embossing 24 of the spring support 21 via the contact pieces 22 to the slip ring is established. In order to obtain a surface that is conductive for long periods of time, the contact pieces 22 are made from a precious metal or a precious metal alloy, at least on their surface.

During installation of the spring support 21, the planar embossing 24 is touched against a surface at the installation site, such that the fastening thus achieved is stable against twisting of the spring support 21. Twisting must be prevented since the contact pieces 22 are arranged on only one side of the wire of the spring support 21. Having the embossing 24 also attains that the pre-determined bending sites on the spring support 21 are given for the formation of the V-shape. What this achieves is that the contact pieces 22 are situated exactly in opposite position in the V-shape.

FIG. 4 shows a schematic view of an alternative embodiment of a spring contact having an elongated cylindrical spring support 31 having two contract pieces 32 arranged on the two ends of the spring support 31. The cylindrical contact pieces 32 are positioned in two embossings having connecting surfaces 33 in the spring support 31. Two notches 35 are provided between the two contact pieces 32. These notches 35 are weak points at which the spring support 31 can be bent. This allows the spring contact to be bent to V-shape only in the pre-determined desired directions.

All spring contacts shown here can just as well be designed to have twisted leaf springs as a spring support 1, 11, 21, 31, rather than from wires having a circular cross-section. A twisted leaf spring can be formed from a piece of sheet metal having an elongated, flat shape. For this purpose, the sheet metal is twisted by at least 180° along the symmetry axis of the elongated side of the rectangle, i.e. twisted such that the leaf spring forms a coil. The coil thus formed can be bent in all directions and has largely symmetrical rigidity with respect to the plane perpendicular to the torsion axis.

The symmetrical design of the spring support 1, 11, 21, 31 via a twisted leaf spring or a cylindrical wire causes the spring support 1, 11, 21, 31 to possess symmetrical rigidity in some regions. This generates not only the requisite spring force for establishing the sliding contact, but also the mobility perpendicular to this spring force attains tolerance during the installation of the spring contact. Accordingly, the spring contacts according to the invention are easier to install.

The features of the invention disclosed in the preceding description and in the claims, figures, and exemplary embodiments, can be essential for the implementation of the various embodiments of the invention both alone and in any combination.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-12. (canceled)

13. A spring contact for a sliding contact having a terminal region (24) and at least one contact region comprising an elongated spring element and a precious metal, the spring contact comprising a conductive spring support (1, 11, 21, 31) and at least one contact piece (2, 12, 22, 32), wherein the spring support (1, 11, 21, 31) has essentially symmetrical rigidity in some regions in a plane perpendicular to an elongated extension of the spring support (1, 11, 21, 31), the spring support being made of a conductive material essentially free of precious metal, wherein the at least one contact piece (2, 12, 22, 32) is conductively connected to the spring support (1, 11, 21, 31) and comprises at least one surface to form the sliding contact, and wherein the at least one surface of the contact piece (2, 12, 22, 32) comprises a material selected from a precious metal and a precious metal alloy.

14. The spring contact according to claim 13, wherein the at least one contact piece (2, 12, 22, 32) has a shape selected from cylindrical, spherical, U-shaped, profiled with welding nipples, and semi-spherical.

15. The spring contact according to claim 13, wherein the at least one contact piece (2, 12, 22, 32) consists of one of the following: a solid precious metal, a precious metal alloy, a jacketed wire (2), and a jacketed sphere (12) having a precious metal-containing jacket.

16. The spring contact according to claim 13, wherein the spring support (11, 21, 31) has a shape selected from flat, hollow and profiled at at least one connection (13, 23, 33) to the at least one contact piece (12, 22, 32).

17. The spring contact according to claim 13, wherein at least two contact pieces (22, 32) are provided at two ends of a V-shaped spring support (21, 31).

18. The spring contact according to claim 17, wherein the terminal region (24) is arranged at a middle of the spring support (21, 31).

19. The spring contact according to claim 18, wherein the terminal region (24) is arranged centrally between to the two contact pieces (22, 32).

20. The spring contact according to claim 18, wherein the terminal region has a flat embossing and bevels for bending of the V-shaped spring support (21).

21. The spring contact according to claim 18, wherein the terminal region has at least one notch (35) for bending of the V-shaped spring support (31).

22. The spring contact according to claim 13, wherein the spring support (1, 11, 21, 31) is a spring wire having a round cross-section with symmetrical rigidity, at least in some regions, in the cross-sectional plane.

23. The spring contact according to claim 13, wherein the spring support (1, 11, 21, 31) is a twisted leaf spring having symmetrical rigidity with respect to at least one region of the twisted leaf spring in a plane perpendicular to a torsion axis.

24. The spring contact according to claim 13, wherein at least one of the spring support (1, 11, 21, 31) and the contact piece (2, 12, 22, 32) comprises a piece of wire having a diameter of up to 2 mm.

25. The spring contact according to claim 13, wherein at least one of the spring support (1, 11, 21, 31) and the contact piece (2, 12, 22, 32) comprises a piece of wire having a diameter of 0.1 mm to 1 mm.

26. A slip ring transmitter comprising a spring contact according to claim 13, wherein the at least one contact piece (2, 12, 22, 32) touches against at least one slip ring via the at least one surface.

27. An electrical motor having a slip ring transmitter according to claim 26.

28. A dynamo having a slip ring transmitter according to claim 26.
